(19) United States
(12) Patent Application Publication
(10) Pub. No.: US 2002/0157512 A1
(43) Pub. Date: Oct. 31, 2002

(54) Portable apparatus for shearing multi-walled workpieces

(76) Inventor: Wayne C. Fasske, Marion, CT (US)

Correspondence Address: CUMMINGS AND LOCKWOOD, GRANITE SQUARE, 700 STATE STREET, P O BOX 1960, NEW HAVEN, CT, 06509-1960, US

(21) Appl. No.: 10/104,302

(22) Filed: Mar. 22, 2002

Related U.S. Application Data
(63) Continuation-in-part of application No. 09/658,353, filed on Sep. 11, 2000, now Pat. No. 6,439,089.
(60) Provisional application No. 60/278,094, filed on Mar. 23, 2001.
(60) Provisional application No. 60/337,700, filed on Nov. 6, 2001.

(51) Int. Cl. B26D 3/00; B26D 5/20

(52) U.S. Cl. 83/169; 83/76.9; 83/54; 83/522.19; 83/639.1; 83/859

(57) ABSTRACT

A portable apparatus for shearing workpieces has a housing defining an interior to enclose a cutting head assembly during storage. During use, an actuator erects the cutting head into an operative position and the cover of the housing defines a planar work surface adjacent to the cutting head fixed thereto. The portable apparatus includes a portable power supply for remote operation.

### CROSS-REFERENCE TO RELATED APPLICATION

This patent application claims prority to U.S. Provisional Patent Application No. 60/278,094, filed Mar. 23, 2001 and to U.S. Provisional Patent Application No. 60/337,700, filed Nov. 6, 2001, and is a Continuation-In-Part of U.S. patent application Ser. No. 09/658,353, filed Sep. 11, 2000, entitled “Apparatus For Shearing Multi-Walled Workpieces”, co-pending herewith, and each application is hereby expressly incorporated by reference as part of the present disclosure.

### FIELD OF THE INVENTION

The present invention relates to a portable apparatus for cutting sheet-like material, and more particularly, to an apparatus for shearing workpieces which can be easily and safely transported, assembled, and disassembled.

### BACKGROUND OF THE INVENTION

Metal framing studs are used in the building industry, and particularly the commercial building industry, for constructing framework and mounting thereto wallboards formed of sheet rock and other types of materials. Although framing studs may be formed in a variety of different shapes and configurations, a common type of stud is formed of metal, and defines a back wall and two parallel side walls forming a generally U-shaped cross section. Commercially available studs are supplied in standard lengths, and therefore if a non-standard length is required, a standard stud must be trimmed to the desired length. Stud trimming is often performed at job sites by employing a chop saw having an abrasive wheel, disk or like rotatably-driven blade, which is pivotally mounted on a base for movement into and out of engagement with a workpiece. The chop saw blades can wear relatively quickly, particularly when used to cut heavy-gauge workpieces. In addition, because of limitations in blade size, many chop saws cannot cut through relatively large-width studs with a single cutting stroke, but rather require the stud to be flipped over after cutting through one side, and then cut again in order to cut through its entire width. Use of a chop saw to trim framing studs or like workpieces can therefore be a relatively time-consuming, labor-intensive and expensive operation, particularly at large job sites or jobs otherwise requiring a large number of studs or like workpieces to be trimmed.

Manufacturers of framing studs, eavestroughs or like workpieces have employed machines for shearing such workpieces to their desired lengths at the time of manufacture. A typical such machine employs a guillotine-like cutting blade slideably received within a blade gap, and a pair of die plates mounted on opposite sides of the guillotine relative to each other for slideably receiving and supporting the workpiece during a cutting operation. Each die plate defines an aperture which is shaped to conform to the shape of a respective type and size of workpiece for conformably engaging the workpiece. A typical such apparatus is shown in U.S. Pat. No. 4,218,946 to Witzler, entitled “Cutter Assembly For Eavestrough-Forming Machine” and is incorporated herein by reference.

One of the drawbacks of these types of conventional shearing machines is that they cannot be conveniently transported and employed for cutting a variety of different pre-manufactured studs, eavestroughs or like workpieces. Each die plate typically forms an aperture defining a fixed shape and dimension conforming to a manufacturer's particular type and size of workpiece, and therefore can only be used with the respective type of workpiece. Moreover, trimmed portions can stick in the shearing mechanism preventing further operation of the machine. In addition, framing studs and like workpieces frequently become bent or otherwise slightly deformed during transportation or even worse during shearing, thus preventing such workpieces from being received within their corresponding die plates. Accordingly, although such a machine could be used to cut a variety of framing studs or like workpieces by providing a variety of die plates having apertures of different shapes and configurations, this would not only be relatively expensive, but any slightly deformed workpieces could not be received within the die plates, and thus could not be cut by the machine. Another drawback of the conventional shearing machines is the relatively short lifetime of the blade. It would be desirable to have a machine that is designed for an improved blade life, and that further allows for a smooth finish on the cut surfaces of the workpieces.

An additional drawback of these typical shearing machines is their lack of portability. As noted above, it is highly desirable to have an efficient shearing machine at the job site. Although several systems have been developed to facilitate moving a shearing apparatus, the intended moves are merely from one location to another in the same room. Some examples are U.S. Pat. Nos. 4,012,934 to Stone et al. and 3,678,724 to Stone et al., each of which is incorporated herein by reference. There are problems associated with the teachings of both Stone et al. patents. In particular, simply providing casters on an otherwise stationary shearing apparatus does not facilitate transporting the machines between job sites. A majority of the operative components remain exposed and therefore subject to damage during transport. A difficult manual adjustment is required to erect the cutting mechanism to a shearing position. Additionally, the apparatus of Stone et al. are bulky and cumbersome for moving in any manner except across a level floor with ample clearance. There is a need, therefore, for an improved portable shearing apparatus which permits easy transport, aids in assuring undamaged transport, easy assembly and disassembly, proper shearing of the workpieces and proper ejection of the trimmed portion of the workpiece.

### SUMMARY OF THE INVENTION

Accordingly, it is an object of the present invention to overcome the drawbacks and disadvantages of the above-described machinery for cutting metal studs, eavestroughs or like multi-walled workpieces.

It is one advantage of the subject disclosure to provide a self-contained portable unit which allows for easy set up at job sites without facilities.

It is another advantage of the subject disclosure to provide an efficient, long-lasting safe shearing apparatus for cutting workpieces to desired measurements.

It is an advantage of the subject disclosure to provide an integrated apparatus for shearing workpieces which can be stored and/or transported securely.

It is still another advantage of the subject disclosure to provide an apparatus for shearing multi-walled workpieces with a work surface which is convenient, durable and replaceable.

It is another advantage of the subject disclosure to provide an apparatus for shearing multi-walled workpieces which ejects the trimmed portions to prevent jamming of the apparatus.

Preferably, an apparatus for shearing workpieces includes a housing defining an interior and a work surface. A cutting assembly is pivotally coupled to the housing, and pivotable between a storage position located within the interior for storage of the cutting assembly and transport of the apparatus, and a shearing position wherein the cutting assembly is adjacent to and substantially perpendicular to the work surface.

Another embodiment is a portable apparatus for shearing workpieces having at least two sides formed of sheet-like material. The apparatus includes a housing defining an interior and a cutting assembly attached to the housing. The cutting assembly has a first support defining an elongated edge and being engageable with a first side of the workpiece for contacting and supporting the first side of the workpiece along a line defined by the first elongated edge wherein a first section of the first elongated edge adjacent to the workpiece is angled with respect to the line. The cutting assembly also has a second support defining an elongated edge and being engageable with a second side of the workpiece for contacting and supporting the second side of the workpiece, the second support being spaced apart from and facing the first support and defining a channel therebetween for receiving the workpiece, wherein a first section of the first elongated edge adjacent to the workpiece is angled with respect to the line. A blade is slideably received within a gap formed adjacent to the elongated edges of the first and second supports and being movable between a first position spaced away from the workpiece within the channel and a second position in engagement with the workpiece for shearing the workpiece along a line of contact and a base support defines a support surface extending between the elongated edges and being engageable with a third side of the workpiece. An actuator is operatively connected between the cutting assembly and the housing for fixedly moving the cutting assembly between a transport position and a shearing position and a plurality of wheels depending from the housing for transporting the apparatus.

These and other unique features of the system disclosed herein will become more readily apparent from the following description, the accompanying drawings and the appended claims.

### BRIEF DESCRIPTION OF THE DRAWINGS

FIG. 1 is a perspective view of an apparatus embodying the present invention illustrating the housing in the transport position in accordance with the subject disclosure.

FIG. 2 is a perspective view of the apparatus of FIG. 1 illustrating the housing in the open position in accordance with the subject disclosure.

FIG. 3 is a perspective view of the apparatus of FIG. 1 illustrating the erection of the cutting head assembly in accordance with the subject disclosure.

FIG. 4 is a perspective view of the apparatus of FIG. 1 illustrating the cutting head assembly oriented in the cutting position in accordance with the subject disclosure.

FIG. 5 is a perspective view of the apparatus of FIG. 1 illustrating the cover in the closed position and defining the workpiece supporting surface, and illustrating the cutting head assembly in the upstanding cutting position in accordance with the subject disclosure.

FIG. 6 is a perspective view of the cutting head assembly in accordance with the subject disclosure.

FIG. 7 is a partial cross-sectional view taken along line 7-7 of FIG. 6 with parts removed for clarity in accordance with the subject disclosure.

FIG. 8 is a side elevational view with the right support of the frame removed for clarity in accordance with the subject disclosure.

FIG. 9 is a partial, front elevational view of another embodiment of the present invention including angled blade supports that are laterally movable in accordance with the subject disclosure.

FIG. 10 is a partial, front elevational view of the apparatus of FIG. 9 illustrating in further detail the lubricating components in accordance with the subject disclosure.

FIG. 11 is a plan view of the support illustrating the channel for receiving lubricating fluid and an angled surface in accordance with the subject disclosure.

FIG. 12 is a front elevational view of another embodiment of a blade wherein the blade includes ejection hooks in accordance with the subject disclosure.

FIG. 13 is a side view of an adjustable material stop in accordance with the subject disclosure.

### DETAILED DESCRIPTION OF THE PREFERRED EMBODIMENTS

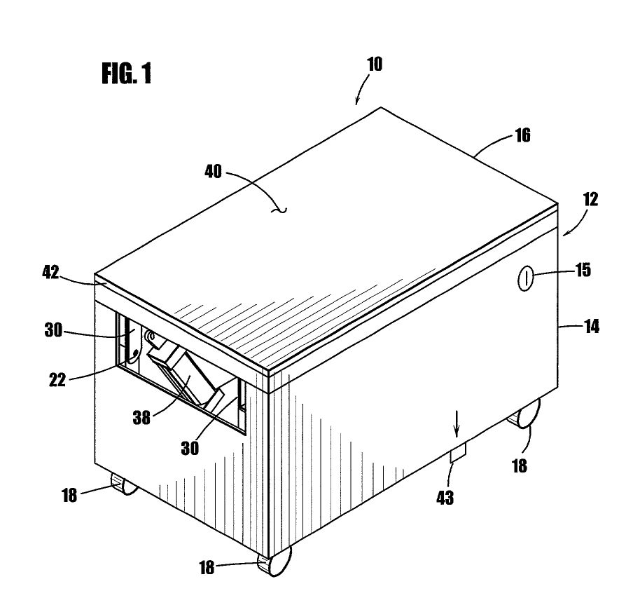

In FIG. 1, an apparatus embodying the present invention is indicated generally by the reference numeral 10. The apparatus 10 comprises a housing 12 including a base 14 and a top 16 pivotally mounted to the base 14. The housing 12 includes a lock 15 for securing the top 16 during transport. A plurality of wheels 18 depend from the base 14 for portability. Additionally, the apparatus can be moved by forklift or boom truck. In the transport position, the closed housing 12 allows employing the apparatus 10 at a job location without excessive difficulty or manpower.

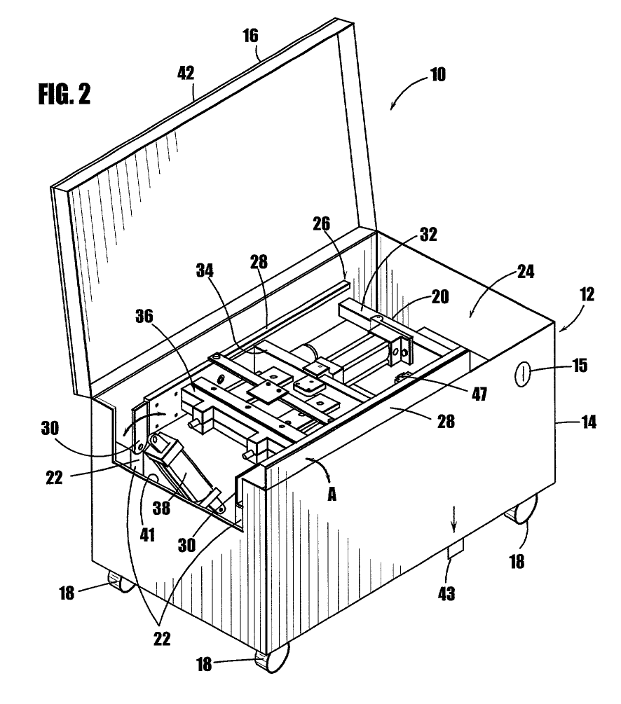

As shown in FIG. 2, the apparatus 10 includes a cutting head assembly 20 pivotally mounted at hinges or pivot joints 22 within an interior 24 of the housing 12. The head assembly 20 comprises a frame 26 including a pair of vertical or upstanding supports 28 spaced laterally relative to each other and pivotally connected to the base 14 by respective hinge supports 30. As can be seen, each hinge support 30 is pivotally mounted to the base 14 by a respective hinge or pivot joint 22. The frame 26 further includes a first laterally-extending or horizontal support 32 extending between the upper portions of the upstanding supports 28 and fixedly secured thereto. A second laterally-extending or horizontal support 34 is spaced below the first support 32 and also extends between and is fixedly secured to the upstanding supports 28. A cutting base assembly 36 is spaced below the second laterally-extending support 34 and is fixedly secured to the lower portions of the upstanding supports 28. A typical cutting head assembly 20 may weigh 300 pounds.

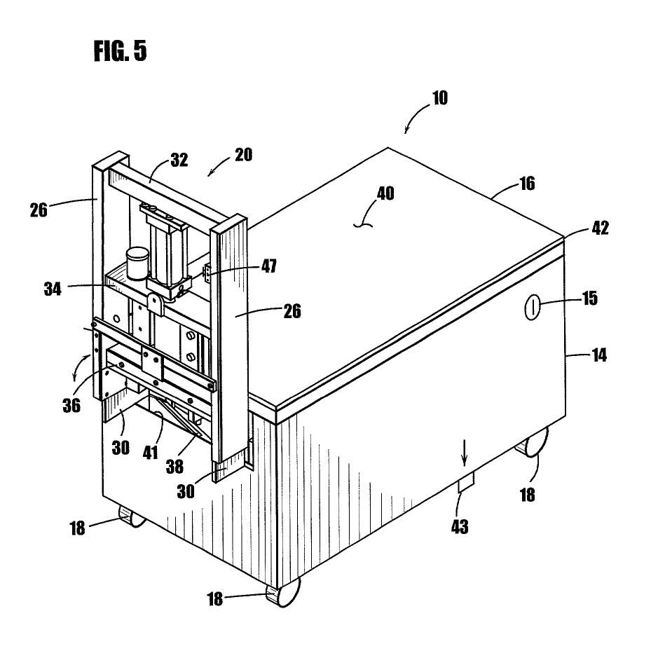

An actuator 38 is drivingly connected between the frame 26 and the base 14. As shown in FIGS. 2 through 5, the actuator 38 is actuated to pivotally move the cutting head assembly 20 between a storage position and a cutting position for easy set up. As shown in FIGS. 1 and 2, the cutting head assembly 20 is located in the storage position contained within the interior 24 of the base 14. Then, upon opening the cover 16 into the position shown in FIG. 2, the actuator 38 may be actuated to drive the cutting head assembly 20 upwardly, as indicated by the arrow A in FIGS. 2, 3 and 4, into the cutting position of FIG. 5. In a preferred embodiment, springs are attached to the cutting head assembly 20 to counterbalance the weight and allow manual rotation of the head assembly 20 between the storage and operating positions.

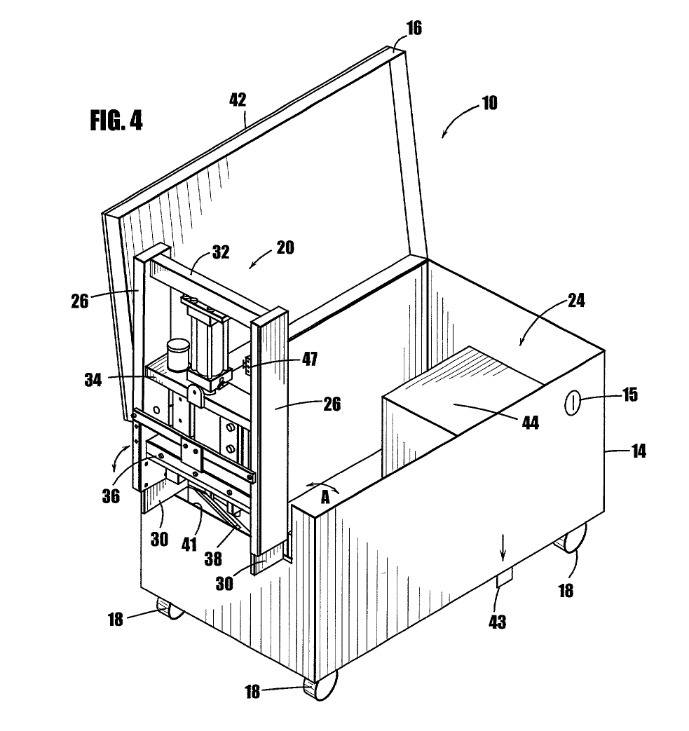

As shown in FIGS. 4 and 5, the base 14 defines a stop surface 41 that engages the supports 30 to erect the cutting head assembly 20 in an upstanding cutting position. Upon moving the cutting head assembly 20 into the upstanding cutting position of FIG. 5, the cover 16 is closed, and the upper surface 40 of the cover 16 defines a planar work-supporting surface for supporting the workpieces (not shown) to be fed, or being fed through the cutting head assembly 20.

In a currently preferred embodiment, a sheet 42 of suitable material, such as steel, is fixedly secured, such as by screws or other fasteners, to the top side of the cover 16 to form a durable, replaceable workpiece supporting surface. In a preferred embodiment, the sheet 42 is heavy gauge diamond plate aluminum. Preferably, the sheet 42 includes ruled marks for allowing the user to measure the workpieces.

Referring now to FIG. 13, preferably an adjustable material stop 180 is provided. The adjustable material stop 180 includes a pipe 182 for securing a linear member 184 a desired distance from the cutting head assembly 20. The linear member 184 provides a reference surface for allowing repeated cuts of workpieces to the desired length. The pipe removably engages the cutting head assembly 20 to allow for removal during transport. Preferably, the components of the adjustable material stop 180 are securely stored within the housing 18 during transport but it will be appreciated by those skilled in the art that the pipe 182 may be of any desired length. The pipe extends along the top 16 parallel to the elongated workpiece. The linear member 184 slidingly attaches to the pipe 182 at any desired location. Preferably, a V-shaped cradle 186 couples the linear member 184 to the pipe 182. The V-shaped cradle 186 forms a triangle with an end of the linear member 184 and the pipe 182 easily slides through such triangle. A locking bolt 188 passes through a threaded hole 190 in the linear member to frictionally engage the pipe 182 and fix the adjustable material stop 180 thereto.

A blade actuator 43 is located slightly under the housing 12 to insure against accidental activation and remote from the cutting head assembly 20 in the cutting position to insure the operator is at a safe distance during operation. Preferably, the blade actuator 43 is a foot stirrup design. In another embodiment, the blade actuator 43 is a remote control which activates the cutting head assembly 20 by infra-red signal as would be known to those skilled in the pertinent art. In still another embodiment, the blade actuator 43 is a push-button switch connected to the apparatus 10 by an electrical cable. A console 47 contains an emergency off push-button switch. Preferably, the console 47 also includes a keyed ignition for starting the motor assembly 44, an automatic cut counter and warning lights for the oil pressure, alternator and the like. In another embodiment, the console 47 also includes an hour meter for tracking the hours of operation to notify the user that a portable energy source, such as a battery recharge, may be required. It is also envisioned that the portable energy source may be gasoline, a solar cell and the like as would be appreciated by those of ordinary skill in the pertinent art upon review of the subject disclosure.

Upon completing the cutting operation, the cover 16 is lifted into the open position of FIG. 4, and the actuator 38 is operated to pivotally drive the cutting head assembly 20 back into the enclosure of the base 14, as illustrated in FIGS. 2 through 4. Then, upon moving the cutting head assembly 20 into the storage position of FIG. 2, the cover 16 is moved into the closed position of FIG. 1, and the apparatus 10 may then be moved for storage or transported to another job site.

In the illustrated embodiment of the present invention, the actuator 38 is in the form of a hydraulic cylinder. However, as may be recognized by those skilled in the pertinent art based on the teachings herein, the actuator may take the form of any of numerous different actuating mechanisms that are currently or later become known for performing the functions of the actuator described herein, such as a pneumatic cylinder, an electric motor or other type of motor, with or without a suitable gear train or linkage mechanism.

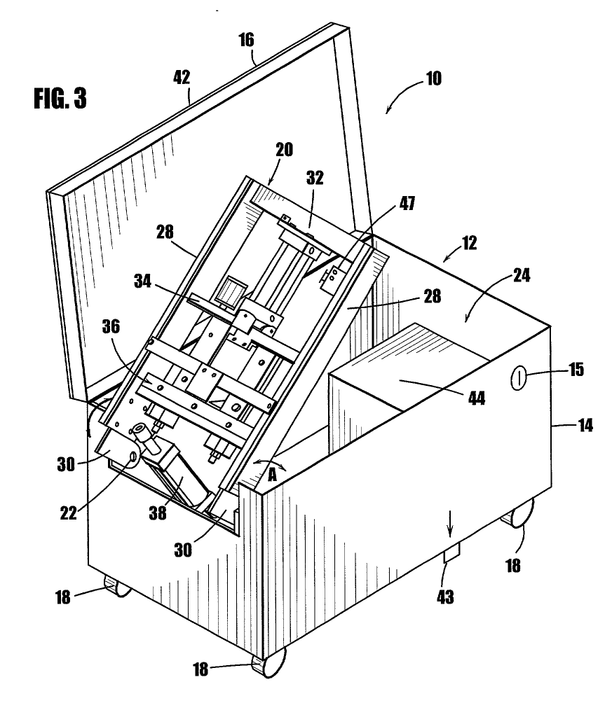

As shown in FIGS. 3 and 4, the base 14 includes a motor housing 44 containing a motor (not shown) for driving a pump for the hydraulic components or otherwise for driving the various components of the apparatus 10. In the currently preferred embodiment of the present invention, the motor is gasoline powered to allow the apparatus to be operated at job sites without electricity. However, as may be recognized by those skilled in the pertinent art based on the teachings herein, any of numerous different types of drive sources that are currently or later become known for performing the functions of the motor may be equally employed, such as an electric motor.

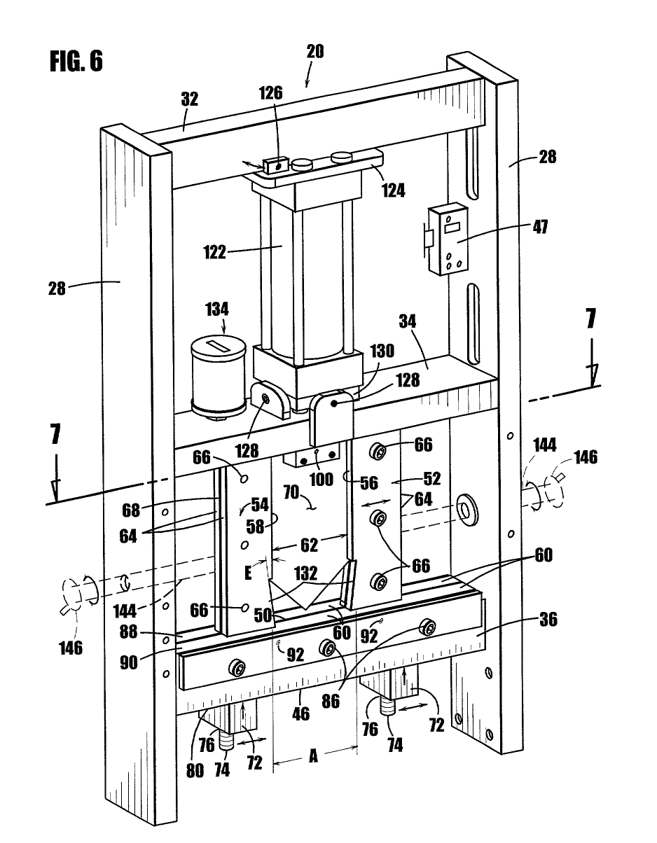

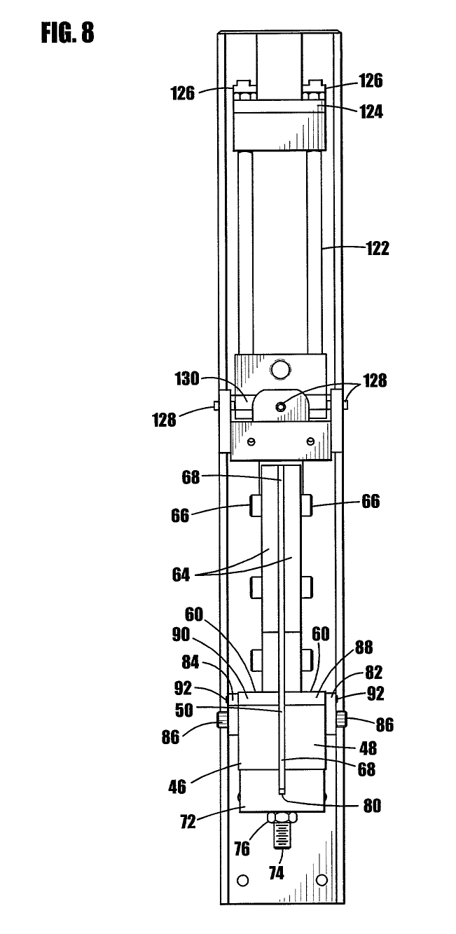

Turning to FIG. 6, the base assembly 36 of the cutting head assembly 20 includes a first base support 46 and a second base support 48, each of which define an elongated edge separated by, as shown in FIG. 8, a blade gap 50. As shown in FIG. 6, a first support 52 is movably mounted on one side of the first and second base supports 46 and 48, respectively, and a second support 54 is movably mounted on the opposite side of the first and second base supports. The support 52 defines two first support surfaces 56 for engaging a first side of a workpiece (not shown), and the second support 54 defines two second support surfaces 58 for engaging a second side of the workpiece. Each base support 46 and 48 similarly defines a third support surface 60 extending between the first and second support surfaces 56 and 58, respectively, for engaging and supporting a third side of the workpiece. The first support surfaces 56 are spaced apart from and face the second support surfaces 58, thus defining a channel 62 therebetween for receiving the workpiece. At least one of the first and second support surfaces 56 and 58, respectively, is movable relative to the support surface on the opposite side of the channel 62 for adjusting the width “A” of the channel to thereby engage with each support surface the respective sides of workpieces of different widths.

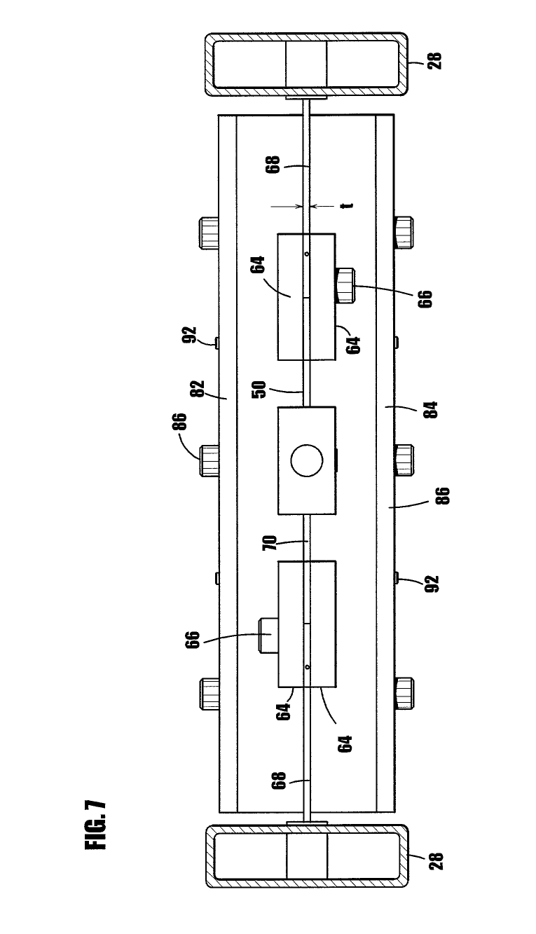

Referring to FIG. 6, the first support 52 will now be described in further detail, although it will be understood that the second support 54 may be similar and for clarity the second support will not be described in detail. The first support 52 may be composed of a suitable metal and comprises a pair of upstanding members 64 that are interconnected or secured together via fasteners 66. The upstanding members 64 are disposed about a shim 68 which, as shown in FIG. 7, defines a thickness (t) of a blade gap 50. It will be appreciated that the thickness (t) of the shim may be varied depending on the size of a shearing means or blade 70. The shim 68 may be formed from a piece of metallic flat stock having a generally rectangular outer configuration and may comprise apertures (not shown) wherethrough the fasteners 66 may extend. As shown in FIGS. 6 and 8, the shim 68 terminates in a locking device 72 which may include a threaded rod 74 connected thereto by suitable means, such as welding. A nut 76 may be employed for securing the first support 52 into engagement with the first and second base supports 46 and 48.

As further shown in FIG. 8, each locking device 72 defines a slot 80 for receiving therein the lower end of the shim 68 fixedly secured to the threaded rod 74. The slot 80 is generally an elongated rectangular channel. A pair of coupling members 82 and 84 are employed that may be connected via fasteners 86 to the base supports 46 and 48. A pair of second base members 88 and 90 are disposed on the base members 46 and 48, respectively, and together comprise the third support surface 60. The base members 88 and 90 are secured to the shim 68 via, e.g., set screws 92, each located on a respective coupling member 82 and 84, to thereby define the width of the blade gap 50 extending through the third support surface 60 and to secure the base members in place.

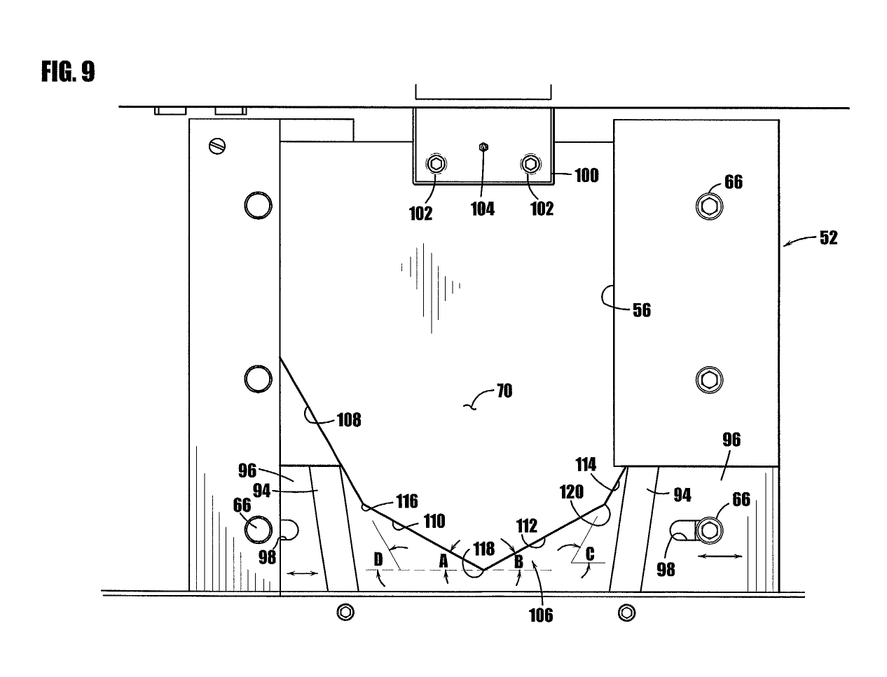

As shown typically in FIG. 9, a portion 94 of the first support surface 56 may be angled at an acute angle, preferably approximately 45°, relative to the plane defined by the blade 70 in order to provide for angular cuts as described in the above-mentioned co-pending patent application. Correspondingly, the second support surface 58 preferably comprises another angled portion 94 located diagonally opposite from that of the corresponding angled portion 94 on the first support surface, such that a workpiece may be accommodated for an angular cut. It will be recognized that the portions 94 may be angled at any particular angle in order to accommodate a variety of workpiece shapes and to permit a predetermined range of angular cuts to be made. It also will be recognized that four angular surface portions, rather than two, may be employed. In order to adjust the contact location between the angled portion 94 and the workpiece, a segment 96 of the each support 52 and 54 may be separately movable therefrom. To allow separate movement and locking of each segment 96, a slot 98 is formed in the segment wherethrough the respective fastener 66 is disposed. As indicated by the arrow in FIG. 9, each segment 96 may be moved laterally relative to the remainder of the support 52 or 54 and then locked in a selected position by adjusting the respective fastener 66.

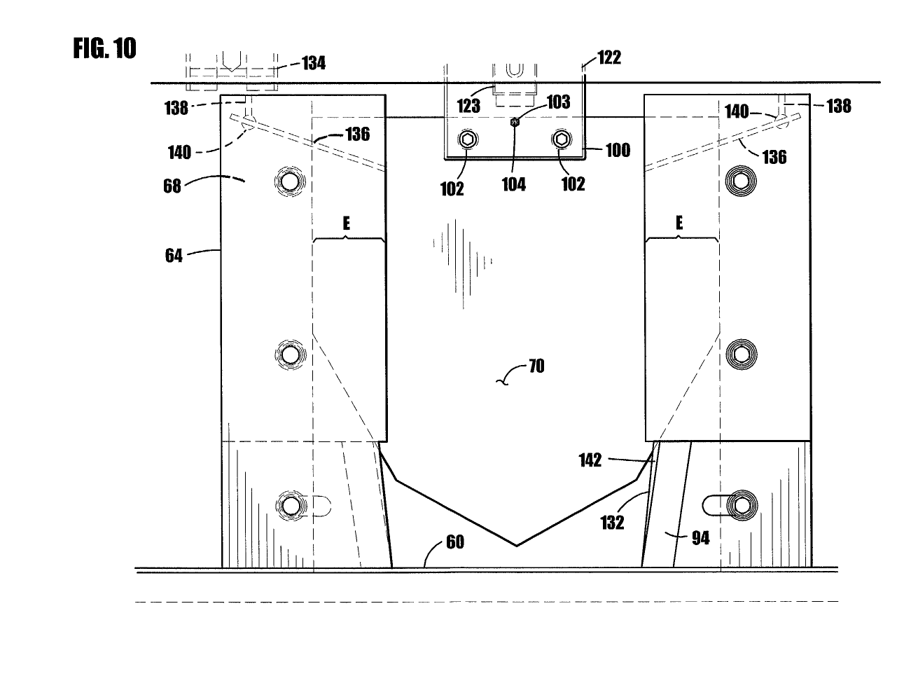

As shown typically in FIG. 9, the blade 70 comprises a support flange 100 affixed by, e.g., fasteners 102, to the blade. The blade 70 includes detents (not shown) corresponding in position to each of the fasteners 102 to locate the position of the blade in the support flange. In addition, the blade defines a recess 103 (FIG. 10) in its upper edge, and a locating pin 104 extending through the flange is received within the recess in the upper edge of the blade to further locate the blade in the flange.

The blade 70 is generally planar and has a transverse axis that is generally parallel to the longitudinal axis of the support flange 100. The blade 70 includes a cutting edge 106 that comprises multiple planar surfaces 108, 110, 112, and 114 each of which comprises cutting side edges on the front and back sides of the blade. The surfaces 108, 110, 112, and 114 are illustrated as planar, although, it will be appreciated that a serration or relatively small teeth may be disposed on the surface. Each surface is separated by cutting tips 116, 118 and 120. It will be recognized that while three cutting tips are preferable, additional cutting tips such as five or seven may be employed. The multiple surface and cutting tip configuration of this embodiment of the cutting blade functions to apply additional pressure adjacent to each of the cutting tips 116, 118 and 120 beyond that of the surfaces 108, 110, 112, and 114 for puncturing, cutting and/or creating multiple fractures through a workpiece. In addition, as shown in FIG. 9, cutting tips 116 and 120 are advantageously located such that they may act to puncture and shear the outer flanges of a workpiece (not shown). This multi-tip structure has been found to be particularly advantageous since the outer flanges are supported at only one end and thus may tend to bend rather than be cut when less than three cutting tips are employed.

Each of the tips 116, 118 and 120 is formed by the intersection of planes defined by surfaces 108, 110, 112, and 114, respectively. The intersection of such planes defines angles A, B, C, and D as shown in FIG. 9. The secondary angles C and D are preferably substantially the same and are greater than the primary angles A and B, and may be within the range of between approximately 45° and approximately 75°, and in the illustrated embodiment, are approximately 60°. The primary angles A and B may be within the range of approximately 15° and approximately 45°, and in the illustrated embodiment is approximately 30°. As may be recognized by those skilled in the pertinent art based on the teachings herein, the greater the secondary angles, the less cutting force (or hydraulic pressure) required to cut the workpieces. One advantage of the compound cutting blade 70 of the present disclosure is that it permits a more compact head assembly 20 in comparison to one employing only two cutting edges, and thereby allows a shorter cutting stroke of the blade 70.

A blade drive 122 is mounted between the first and second laterally-extending supports 32 and 34, respectively, and is drivingly connected to the support flange 100 of the blade 70 to drive the blade upwardly and downwardly through the blade gap 50 to cut the workpieces. In the illustrated embodiment, the blade drive 122 is in the form of a hydraulic cylinder. However, as may be recognized by those skilled in the pertinent art based on the teachings herein, the actuator may take the form of any of numerous different actuating mechanisms that are currently or later become known for performing the functions of the actuator described herein, such as a pneumatic cylinder, an electric motor or other type of motor, with or without a suitable gear train or linkage mechanism.

An upper mounting plate 124 secures the upper end of the actuator 122 to the first laterally-extending support 32. A pair of jack bolts 126 (only one shown) are mounted on the upper side of the mounted plate 124 such that the free ends of the bolts 126 engage the adjacent wall of the laterally-extending support 32. As indicated by the arrows in FIG. 6, the jack bolts 126 are adjusted to, in turn, adjust the position of the actuator 122 and thereby move the blade 70 forward or backwards for alignment of the blade.

As further shown in FIG. 6, a plurality of secondary jack bolts 128 (only two shown) are each mounted on a respective side at the base of the actuator 122 for engaging the adjacent face of a base plate 130 of the actuator. The secondary jack bolts 128 are adjusted to, in turn, adjust the final position of the actuator and thus of the blade within the blade gap. As shown in FIG. 10, a shaft 123 of the cylinder 122 is secured to the support flange 100 to drivingly connect the blade to the actuator. The shaft 123 is rotatable within the cylinder thus converting the pivotal adjustment of the jack bolts in the forward and backward movement of the blade within the blade gap.

As shown typically in FIG. 6, the base portions 132 of each support surface 56 and 58 are angled inwardly at an acute angle “E”. The base portions 132 is provided to allow the workpiece to flex outwardly upon cutting the workpiece with the blade 70. As a result, the cutting position of the blade 70 shifts laterally along the cutting edge of the blade 70 as the blade 70 moves downwardly through the workpiece and the sides of the workpiece flex outwardly toward the base portion 132. A significant advantage of base portions 132 is to allow for significantly improved blade life since a greater surface area of the blade 70 is being used to cut, for example, the upstanding flanges on metal building studs or like workpieces. Another advantage of the base portions 132 is to allow for a smoother finish on the cut surfaces of the workpieces. Yet another advantage of the base portions 132 is that it provides a wider channel 62 in the vicinity of the workpiece, and thereby facilitates insertion of the workpieces into the apparatus 10 and removal of the workpieces therefrom.

In the preferred embodiment, the angle E is determined to provide inward travel of a distance 133 for each vertical displacement distance 135 of the blade 70. For example, if the inward travel distance 133 is approximately ¼ inch, the vertical displacement 135 would be approximately 3 inches. However, as may be recognized by those skilled in the art based on the teachings herein, the angle E may be any of numerous different angles depending, for example, on the shape and/or size of the workpieces, or the material from which the workpieces are made. In any event, the space between the adjacent sides of the workpiece and the base portion 132 is preferably within the range of flexibility of the workpiece without causing permanent deformation of the workpiece.

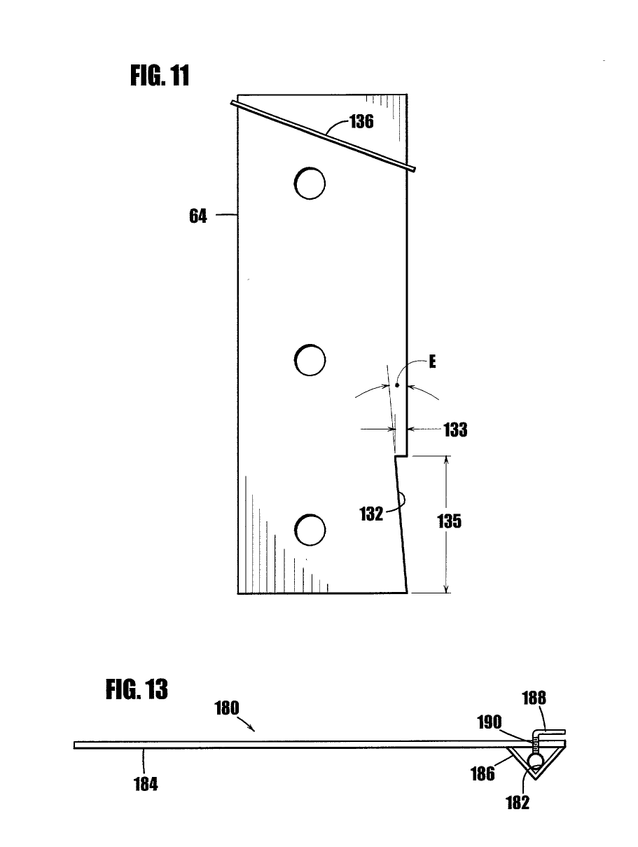

As further shown in FIG. 6, the cutting head assembly 20 comprises a gravity feed oiling system including a pair of oil reservoirs 134 (only one shown), each mounted on the second laterally-extending support 34 over a respective support 52 or 56 and filled with a suitable lubricating oil or other liquid for lubricating the respective side of the blade 70. As shown in FIGS. 10 and 11, each support 64 defines a respective elongated channel 136 thereby forming a fluid conduit extending between the oil reservoir 134 and the portion of the blade gap formed between the respective supports 64. An inlet hole 138 is also formed in the opposing surfaces of the supports 64 to thereby define an inlet conduit connected in fluid communication between the oil reservoir 134 and channel 138. A second reservoir 140 is formed at the junction of the inlet channel 138 and elongated channel 136 and may be formed by a round hole in each support 64. In operation, the oil is released by gravity from the reservoir 134 into the inlet channel 138 and second reservoir 140, and in turn flows by capillary action through the elongated channel 136 and onto the surfaces of the blade 70 received within the portion of the blade gap 50 formed between the opposing plates 64. As a result, the oil effectively lubricates the marginal portions “E” of the blade 70 and thereby ensures adequate lubrication of the cutting surfaces of the blade 70 (i.e., the surfaces cutting the upstanding flanges of the metal framing studs or like workpieces). As shown typically in FIG. 10, the surface 132 may define a chamfer 142 to prevent chipping.

In the operation of the cutting head assembly 20, the workpiece is located in the channel 62 and the first and second supports 56 and 58 may be moved into engagement therewith after loosening of nuts 76. As indicated in phantom in FIG. 6, threaded rods 144 with adjustment wheels 146 may extend through the upstanding supports 28 and engage the supports 56 and 58 to laterally adjust the supports by rotation of the wheels and rods. The blade 70, driven by the drive actuator 122, may then puncture and shear the workpiece by driving the blade downwardly through the workpiece and then returning the blade to the non-cutting position, as shown in FIG. 6. If it is desired that the workpiece be cut at a particular angle, e.g., a 45°, to the longitudinal axis of the workpiece, the lower fasteners 66 in FIG. 9 may be loosened and segment 96 may be moved laterally to engage a side of the workpiece. The shims 68 located between the upstanding members 64 may be replaced, e.g. depending upon a thickness (t′) of the blade 70 as described above, via removal of the fasteners 66 and nut 76 and loosening of set screws 92 of the base members 88 and 90. As shown in FIG. 6, the base assembly 36 may be provided with indicia indicating the width of the channel 62 and the locking members 72 likewise may be provided with pointers for aligning the locking members with the desired measured indicia to thereby precisely set the width A of the channel.

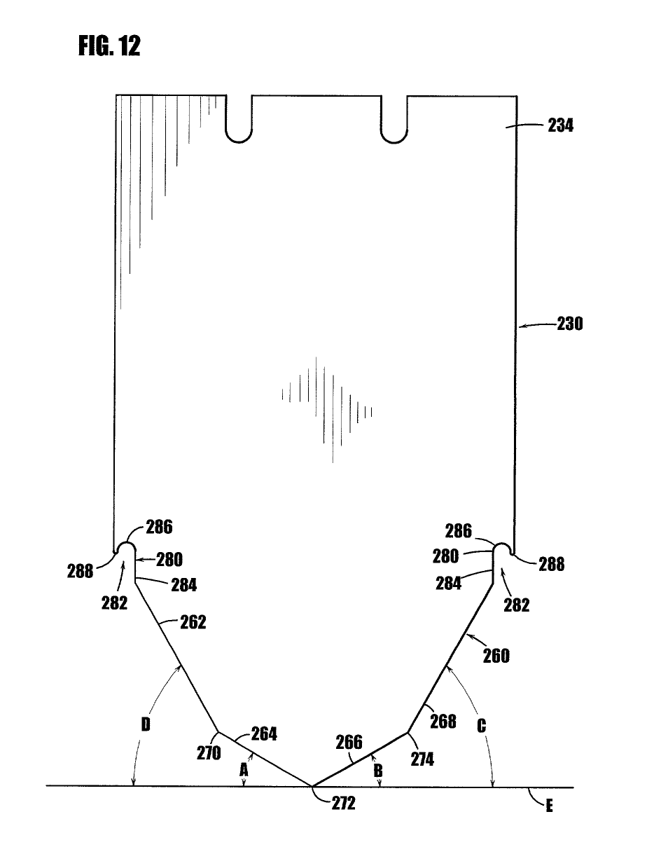

Referring now to FIG. 12, another preferred blade 230 of the cutting head assembly 20 is generally planar and has a transverse axis that is generally parallel to the longitudinal axis of the support flange 234. The blade 230 includes a cutting surface 260 that comprises multiple planar segments 262, 264, 266 and 268. The segments 262, 264, 266 and 268 are illustrated as planar, although, it will be appreciated that a serration or teeth may be disposed on the surface thereof. The segments 262, 264, 266 and 268 are separated by cutting tips 270, 272 and 274. It will be recognized that while three cutting tips are preferable, additional cutting tips such as five or seven may be employed by creating additional segments. When the blade 230 shears a workpiece (not shown), a portion or slug approximately the width of the blade 230 is removed from the workpiece. Typically, the slug remains in the blade gap 50. Eventually, the slugs may collect in the blade gap 50 to prevent further operation of the cutting head assembly 20.

The distal ends of segments 262 and 268 of the blade 230 define ejection hooks 280 for facilitating removal of slugs by engaging thereof. Each ejection hook 280 forms a cavity 282 defined by a linear portion 284, a rounded portion 286 and a point 288. In another embodiment, the points 288 of the ejection hooks 280 are rounded. In still another embodiment, the rounded portions 286 of the ejection hooks 280 are a flat line. Such a flat line portion may be parallel to the transverse axis or at an angle as would be appreciated by those of ordinary skill in the art upon review of the subject disclosure. The ejection hooks 280 force the slugs out of the cutting path, thereby preventing interference during subsequent shearing action.

As may be recognized by those skilled in the pertinent art, numerous changes and modifications may be made to the above-described and other embodiments of the present invention, without departing from its scope as defined in the appended claims. For example, the cutting head assembly may include a blade with ejection hooks, supports with angled base portions, a fluid conduit and combinations thereof. The housing may include handles, locking casters, low friction pads, a combination thereof and the like to facilitate movement. Accordingly, while the invention has been described with respect to preferred embodiments, those skilled in the art will readily appreciate that various changes and/or modifications can be made to the invention without departing from the spirit or scope of the invention as defined by the appended claims.

What is claimed is:

1. An apparatus for storing, transporting and using power equipment comprising:
a) a housing defining an interior and a work surface; and
b) an assembly pivotally coupled to the housing, and pivotable between a storage position located within the interior for storage of the assembly and transport of the apparatus, and an operational position wherein the assembly is adjacent to and substantially perpendicular to the work surface.

2. An apparatus as recited in claim 1, further comprising hinges to secure the work surface to the housing to selectively enclose the interior.

3. An apparatus as recited in claim 1, wherein the work surface is planar and has ruled marks for measuring.

4. An apparatus as recited in claim 1, further comprising a lock integral with the housing for securing the space in the storage position.

5. An apparatus as recited in claim 1, further comprising a heavy gauge diamond plate aluminum sheet secured to the work surface.

6. An apparatus as recited in claim 1, wherein the assembly is for shearing workpieces and further comprising a pair of hinge supports having first and second ends respectively, the first ends connected to the housing by pivot joints and the second ends connected to the assembly.

7. An apparatus as recited in claim 6, wherein the housing defines a stop for supporting the pair of hinge supports and thereby the assembly in the shearing position.

8. An apparatus as recited in claim 1, further comprising an actuator drivingly connected between the assembly and the housing for pivotally moving the assembly from the storage position to the operational position.

9. An apparatus as recited in claim 8, further comprising a motor assembly secured to the housing for driving the actuator and the assembly.

10. An apparatus as recited in claim 9, further comprising a fuel supply secured within the space for powering the motor assembly.

11. An apparatus as recited in claim 8, where the motor assembly defines a stop for the assembly in the storage position.

12. An apparatus as recited in claim 1, wherein the assembly is a drill press.

13. An apparatus as recited in claim 1, further comprising a blade actuator connected to the housing in a location remote from the assembly, the blade actuator for controlling the assembly.

14. An apparatus as recited in claim 1, further comprising a console in communication with the assembly for operator control of the apparatus.

15. An apparatus as recited in claim 14, wherein the console includes an emergency off switch, an hour meter for tracking hours of operation, an automatic cut counter and warning lights.

16. A portable apparatus for shearing workpieces comprising:
a first means defining an interior for storing;
a second means pivotally coupled to the first means; and
an third means mounted between the first means and the second means to move the second means between a storage position within the interior and a cutting position.

17. A portable apparatus as recited in claim 16, wherein the first means is a metal rectangular box having a hinged lid.

18. A portable apparatus as recited in claim 16, wherein the second means includes
a frame having
first support defining an elongated edge and being engageable with a first side of the workpiece for contacting and supporting the first side of the workpiece along a line defined by the edge; and
second support defining an elongated edge and being engageable with a second side of the workpiece for contacting and supporting the second side of the workpiece, the second means being spaced apart from and facing the first means and defining a channel therebetween for receiving the workpiece; and
an elongated blade attached to the frame at a proximal end and slideably received within a gap formed adjacent to the elongated edges of the first and second means and being movable between a first position spaced away from the workpiece within the channel and a second position in engagement with the workpiece for shearing the workpiece along a line of contact, the elongated blade having a cutting surface on a distal end thereof, the cutting surface having at least one cutting tip and defining a pair of cavities, each cavity adjacent to a side of the cutting surface to facilitate ejection of a trimmed portion of the workpiece.

19. The portable apparatus as recited in claim 18, further comprising oiling means fixed to the frame for lubricating the blade.

20. A portable apparatus as recited in claim 19, wherein the oiling means is a reservoir for storing oil and mounted adjacent to a channel whereby when oil exits the reservoir the oil flows by capillary action through the channel and onto the blade.

21. A portable apparatus as recited in claim 16, wherein the third means is a hydraulic cylinder attached to a pump secured within the interior.

22. A portable apparatus for shearing workpieces having at least two sides formed of sheet-like material, comprising:
(a) housing defining an interior;
(b) cutting assembly attached to the housing including:
a first support defining an elongated edge and being engageable with a first side of the workpiece for contacting and supporting the first side of the workpiece along a line defined by the first elongated edge wherein a first section of the first elongated edge adjacent to the workpiece is angled with respect to the line;
a second support defining an elongated edge and being engageable with a second side of the workpiece for contacting and supporting the second side of the workpiece, the second support being spaced apart from and facing the first support and defining a channel therebetween for receiving the workpiece, wherein a first section of the first elongated edge adjacent to the workpiece is angled with respect to the line;
a blade slideably received within a gap formed adjacent to the elongated edges of the first and second supports and being movable between a first position spaced away from the workpiece within the channel and a second position in engagement with the workpiece for shearing the workpiece along a line of contact; and
a base support defining a support surface extending between the elongated edges and being engageable with a third side of the workpiece;
(c) an actuator operatively connected between the cutting assembly and the housing for fixedly moving the cutting assembly between a transport position and a shearing position; and
(d) a plurality of wheels depending from the housing for transporting the apparatus.

23. An apparatus as recited in claim 22, further comprising an adjustable stop threadably coupled to the cutting assembly for providing a reference surface for the workpiece during cutting.

24. A blade for shearing workpieces comprising:
a cutting surface having
a primary point defined by the intersection of two portions;
two secondary points on each side of the primary point, each secondary point defined by one of the two portions and respective secondary portions; and
a cavity adjacent each of the secondary portions for facilitating ejection of trimmed portions of the workpieces.

25. An apparatus as recited in claim 22 where the first sections of the first and second supports are angled to provide ¼ inch displacement of a side of the workpiece for each 3 inches of blade movement therethrough.

26. An apparatus for shearing workpieces comprising:
a) a housing defining an interior and a work surface when in a shearing position;
b) a cutting assembly stored within the interior when in a transport position for shearing workpieces, the cutting assembly pivotally connected to the housing such that in the shearing position, the cutting assembly is substantially adjacent and perpendicular the work surface;
c) an actuator drivingly connected between the housing and the cutting assembly for pivotally moving the cutting assembly;
d) a motor assembly secured to the housing for driving the cutting head assembly and the actuator; and
e) a fuel supply connected to the motor assembly for powering the motor assembly.
